(19) United States
(12) Patent Application Publication
(10) Pub. No.: US 2003/0160810 A1
(43) Pub. Date: Aug. 28, 2003

(54) Methods and systems for internationalizing messages using parameters

(75) Inventors: Stephen C. Talley, Boulder, CO (US); Stephen J. Wolf, Superior, CO (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/084,314

(22) Filed: Feb. 28, 2002

(51) Int. Cl. G09G 5/00

(52) U.S. Cl. 345/703; 345/765; 345/778

(57) ABSTRACT

Systems and methods consistent with principles of the present invention allow localized text and user interface components to be dynamically displayed in a user interface layout. Resource strings may be used to represent localized data. The localized data may contain parameters that are associated with components of a user interface. The parameters may be integrated into a syntactical structure associated with the data. At run-time, the resource strings may be replaced with the data and the parameters may be replaced with the components. The data and components could be arranged in a user interface layout and presented to a user.

### DESCRIPTION OF THE INVENTION

1. Field of the Invention

The present invention generally relates to data processing systems, and more specifically to generating a user interface layout which contains localized textual data as well as elements of the user interface. In one example, parameterized resource strings may be used to create a layout suitable for display in various locales.

2. Description of the Related Art

As the advent of the Internet has shown, computer applications have an international reach, spanning many geographic regions with varying cultures and languages. Thus, it is often desirable to create application programs which can be adapted to different regions or “locales.” This is sometimes accomplished by translating, or “localizing,” certain elements of an application (e.g., textual messages) to a specific language. The localized elements can be maintained external to the source code of the application (e.g., a database or local file) and dynamically retrieved at run-time, thereby permitting the same application to execute in a variety of locales. An internationalized application could identify the specific locale associated with its users by way of the underlying platform. The locale is often determined by an identifier associated with the particular region.

When designing and implementing a graphical user interface (GUI) for an application intended for international use, developers often use “resource strings” in place of textual messages. The resource strings are replaced, at run-time, with the localized versions of the textual messages that they represent. For instance, the resource string “dialog-message” may be defined in the C (English) locale as:

dialog-message=“Please select an appropriate color” However, in the Spanish locale, the resource string could be defined as:

dialog-message=“Favor de escoger un color apropiado” At run-time, “dialog-message” is replaced with the textual message corresponding to the particular locale.

Resource strings have evolved to contain parameters, so that values can be dynamically substituted into the message at run-time. For example, the above-mentioned resource string could also include the following textual parameter:

dialog-message=“Please select an appropriate {0}” or

dialog-message=“Favor de escoger un {0} apropiado” Using this parameterized resource string in which “{0}” represents a parameter, the message could be modified at run-time to read, for example, “Please select an appropriate color”, “Please select an appropriate size”, or “Please select an appropriate font”.

Resource strings may also contain multiple parameters, for example:

dialog-message=“Please select an {1} {0}” or dialog-message=“Favor de escoger un {0} {1}” In this particular example, {0} could refer to a noun and {1} to an adjective describing that noun.

The above-mentioned technique is, however, limited to textual data. When an application requires components of GUI such as buttons, combo boxes, text fields, or spinners to appear within a message, the above-mentioned resource strings and parameters technique is insufficient. For instance, a GUI might display the following string/component combination:

Build [symbol] partitions of size [1024][KB v] where “ [symbol] ” represents a text field where the user can type in an appropriate value, “[1024]” represents a numerical spinner component, and “[KB v]” represents a combo box where the user can choose from a preset list of values (here KB, MB, or GB). Such constructs cannot be internationalized in the same fashion as textual messages.

Current techniques are deficient in their ability to generate a layout of text and components for GUI's at runtime. For example, the “java.text.MessageFormat” class, found in the Java Development Kit which contains tools for compiling, debugging, and executing applications written in the Java programming language, allows parameterized strings to be formatted with a list of text arguments to create a new text message at runtime. However, this class does not allow actual GUI components to be substituted with parameters in order to facilitate new layouts corresponding to new locales.

### SUMMARY OF THE INVENTION

The present invention is directed to methods and systems that substantially obviate one or more of the above and other problems. Consistent with an exemplary embodiment of the present invention, there may be provided methods for automatically generating a layout of localized text and user interface components. In one implementation, a user interface application may employ resource strings that are associated with data (e.g., textual messages). The data could contain parameters, integrated into a syntactical structure of the data, that are associated with components of the user interface. The resource strings may be used to retrieve the data and, upon retrieval, the resource strings may be replaced with the data. In addition, the user interface components may be obtained and inserted in place of the parameters. The data and components may then be arranged and outputted for display.

Consistent with one aspect of the present invention, methods may be provided in a computer system having a graphical user interface. The locale associated with system or a user may be identified. Resource strings may be used to retrieve data associated with the user's locale. This data may contain parameters associated with components of the graphical user interface. The resource strings may be replaced with the data and the graphical user interface components may be obtained. The parameters may then be replaced with the components and the data may be arranged and displayed.

Additional aspects related to the invention will be set forth in part in the description which follows, and in part will be obvious from the description, or may be learned by practice of the invention. Aspects of the invention may be realized and attained by means of the elements and combinations particularly pointed out in the appended claims.

It is to be understood that both the foregoing and the following descriptions are exemplary and explanatory only and are not intended to limit the claimed invention in any manner whatsoever.

### BRIEF DESCRIPTION OF THE DRAWINGS

The accompanying drawings, which are incorporated in and constitute a part of this specification exemplify the present invention and, together with the description, serve to explain principles of the invention.

FIG. 1 is an exemplary block diagram of a system in which the present invention may be practiced;

FIG. 2 is a flowchart illustrating steps of a method consistent with an implementation of the present invention; and

FIG. 3 depicts an exemplary screen shot consistent with an implementation of the present invention.

### DETAILED DESCRIPTION

In the following detailed description reference will be made to the accompanying drawings in which is shown by way of illustration a specific implementation consistent with principles of the present invention. This implementation is described in sufficient detail to enable those skilled in the art to practice the invention and it is to be understood that other implementations may be utilized and that structural changes may be made without departing from the scope of present invention. The following detailed description is, therefore, not to be construed in a limited sense.

Systems and methods consistent with principles of the present invention allow localized text and user interface components to be dynamically displayed in a layout. This may be accomplished through the use of resource strings that represent localized or translated data (e.g., textual messages) stored in a database or file. The data may contain parameters that are associated with user interface components (e.g., graphical user interface components). In certain embodiments, the contents of the components are also localized and stored. At run-time, the resource strings may be replaced with the data and the parameters may be replaced with the components. The data and components might be arranged in a localized layout, which is displayed to a user. Systems and methods consistent with the present invention may be implemented in any type of programming language (e.g., C and Java).

Referring now to the drawings, in which like numerals represent like elements throughout the figures, the present invention will be described.

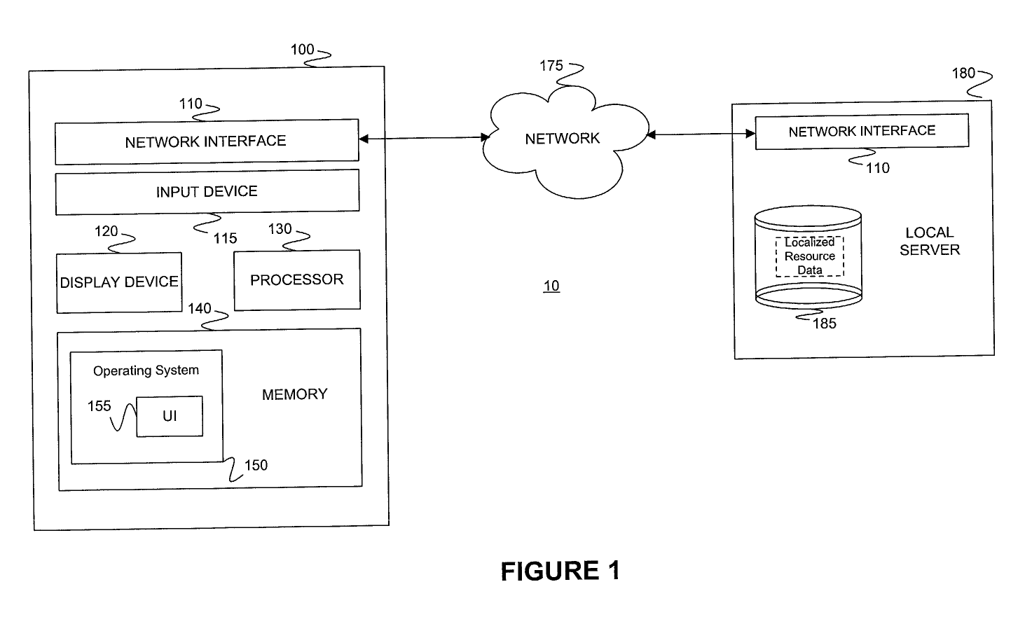

Methods consistent with an exemplary implementation of the present invention may be practiced in system 10 of FIG. 1. As illustrated, system 10 may comprise computer system 100, local server 180, and network 175. Network 175 may be a public network such as the Internet, a virtual private network, or any other mechanism for enabling communication between two or more nodes or locations. The network 175 may include one or more wired and/or wireless connections. Computer system 100 and server 180 may be connected to network 175 via an interface such as network interface 110, which may be operatively connected via a wired and wireless communications link. Network interface 110 may be a network interface card, unit, or any other type of network connection. In operation, network interface 105 may be used to send data to and receive data from network 175. Computer system 100 and local server 180 may be operatively connected to network 175 by communication devices and software known in the art, such as those commonly employed by Internet Service Providers (ISPs) or as part of an Internet gateway.

In addition to network interface 110, computer system 100 may also comprise components such as input device 115, display device 120, processor 130, and memory 140. As used herein, “memory” refers to any mechanism capable of storing information including, but not limited to, RAM, ROM, magnetic and optical storage, organic storage, audio disks, and video disks. As illustrated, memory 140 may further comprise operating system (OS) 150, which includes user interface (UI) 155. Although user interface 155 is shown as part of OS 150, interface 155 may also be configured separately from OS 150. User interface 155 may include any mechanism for allowing a user to interact with computer system 100. For example, user interface 155 may be a graphical user interface (GUI) developed in any type of programming language (e.g., C or Java). Accordingly, processor 130 may be operatively configured to execute program instructions included in user interface source code to perform functions of user interface 155. Consistent with principles of the present invention, the source code for user interface 155 may contain resource strings. As used herein, a “resource string” refers to any number and arrangement of characters (e.g., “message 15”) used to represent data.

Display device 120 may be configured to output text, images, or any other type of information by way of a cathode ray tube, liquid crystal, light-emitting diode, gas plasma, or other type of display mechanism. Display device 120 is used in conjunction with user interface 155 and input device 155 to allow a user to interact with computer system 100.

Input device 115 may include at least one button actuated by the user to input commands and thereby select from a plurality of processor operating modes. Input device 115 may include components such as a keyboard, mouse, and touch screen. Input device 115 may also be an input port connected by a wired, optical, or a wireless connection for electromagnetic transmissions. In alternative implementations, input device 115 may include connections to other computer systems to receive the input commands and data therefrom.

Local server 180 may comprise components similar to those described in connection with computer system 100. In the implementation illustrated in FIG. 1, local server 180 may contain localized resource data associated with the resource strings. The term “resource data” refers to any information, element, or component associated with a resource string. For example, “message 15” may be defined, in English, as “Build {0} partitions of size {1}{2},” having parameters {0}, {1}, and {2}. In the Spanish locale, on the other hand, the associated resource data for “message 15” could include the message “Construya {0} particiones de los {2} de la talla {1}.” The parameters {0}, {1}, and {2} exist in both locales; however, they are arranged differently according to the grammatical structure of the language.

The values of the above parameters {0}, {1}, and {2} may include textual data. Further, these values may include user interface components. As used herein, a user interface “component” refers to any element that displays information or provides a particular means of interaction with an underlying operating system and/or application. User interface components may, in one implementation, refer to GUI components such as, icons, pull-down menus, buttons, selection boxes, combo boxes, spinners, progress indicators, on-off checkmarks, scroll bars, windows, window edges, toggle buttons, forms, or any other element for displaying information and for inviting, accepting, and responding to user actions. In one embodiment, these values could be created by the GUI once the localized data is retrieved. Accordingly, the content of the elements (e.g., numbers in a combo box) may be in the language inherent to the GUI.

However, in alternative configurations, the parameter values may also be localized. For example, the content of a particular GUI component could be translated and maintained external to the source code. Thus, in addition to the textual message represented by the resource string, the parameter values may be included in the resource data retrieved.

In one exemplary configuration, the resource data may be maintained in database 185, as illustrated. Database 185 may include a relational database, distributed database, object-oriented programming database, or any other aggregation of data that can be accessed, managed, and updated. For the sake of brevity, FIG. 1 depicts a single database in a local server. However, it should be understood that a plurality of geographically dispersed servers and databases may exist, each maintaining resource data localized to a specific locale. It should also be understood that resource data may be contained in a database or other storage mechanism residing in computer system 100. Thus, in certain implementations, the resource string(s) and corresponding resource data reside in the same system, thereby rendering local server 180 unnecessary.

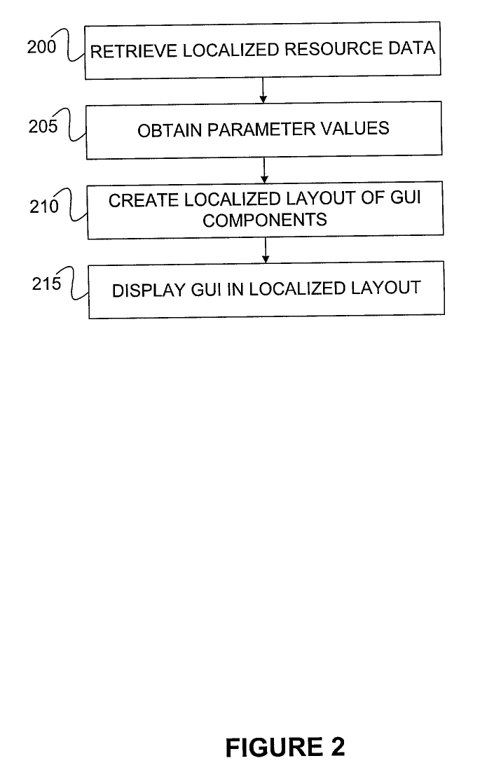

In an exemplary configuration, the operation of the present invention may be consistent with the steps illustrated in the flowchart of FIG. 2. However, it should be understood that other methods may be used to implement the invention, and even with the method disclosed in FIG. 2, the particular order of events may vary without departing from the scope of the present invention. Further, certain steps may not be present, additional steps may be added, and the order of the steps may be modified without departing from the scope and spirit of the invention, as claimed. For purposes of this explanation, it will be assumed that user interface 155 is a GUI.

In accordance with an exemplary configuration of the present invention, user interface 155 may contain at least one resource string. The localized resource data associated with the resource strings may be remotely or locally maintained, as described above. For example, resource data could be maintained in English, French, German, Spanish, or any other language. In one configuration, the GUI may retrieve localized resource data, as indicated in step 200. This step may involve determining which locale a user of computer system 100 is associated with and/or which locale to retrieve the resource data from. As described above, determining the locale may be accomplished by an identifier and may be inherent to the underlying platform. Retrieving may involve using the resource string as a key into database 185. Upon matching the key with the corresponding resource data, the localized data could be transmitted to the GUI. For example, “message 15” may be used to retrieve “Construya {0} particiones de los {2} de la talla {1},” in the Spanish locale.

In one implementation of the present invention, the resource data may be retrieved at run-time. However, one skilled in the art will appreciate that in alternative embodiments, the locale could be hard-coded in an application and, therefore, the resource data might be retrieved and compiled at compile-time.

Upon receiving the resource data associated with the resource strings, GUI components contained in the resource strings may be obtained, as indicated in step 205. As defined above, “message 15” contains parameters {0}, {1}, and {2}. Accordingly, the values for these parameters (e.g., a text field, spinner, and combo box) may be created by the GUI application. However, it should be understood that the content of these GUI components, for example, the numbers which appear in a combo box, may also be localized and retrieved, as explained above.

As depicted in step 210, the resource data may be displayed in a localized arrangement, or “layout”. This step may involve arranging the GUI components in a manner consistent with the data retrieved with the resource key.

Once the resource data has been arranged, the parameter values may be substituted in the message and displayed, via display device 120, as indicated in step 215. In one implementation, parameter values may be substituted at run-time. However, it should be understood that, in alternative configurations, substitution could be performed at compile-time.

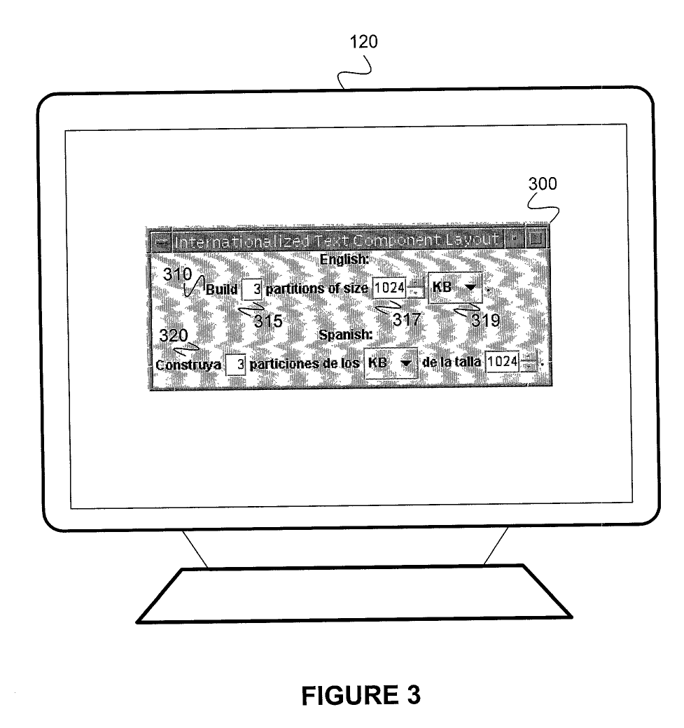

The exemplary screenshot illustrated in FIG. 3 depicts an example of layout consistent with the present invention. Message 310 indicates a layout generated from the resource string: “Build {0} partitions of size {1}{2}.” Similarly, message 320 indicates a layout generated from the same resource string localized in Spanish: “Construya {0} particiones de los {2} de la talla {1}.” In each localization, “{0}” is substituted with a text field, “{1}” is substituted with a numerical spinner component, and “{2}” is substituted with a combo box. As illustrated in FIG. 3, the component arguments may appear in slightly different order between localizations due to variance in syntactical structure.

It should be understood that processes described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

It will be apparent to those skilled in the art that various modifications and variations can be made in the systems and methods of the present invention as well as in the construction of this invention without departing from the scope of or spirit of the invention.

The present invention has been described in relation to a particular example which is intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. In a computer system having a user interface containing at least one resource string associated with data, a method comprising the steps of:
using the at least one resource string to retrieve the data, the data containing at least one parameter associated with at least one element of the user interface, the at least one parameter being integrated into a syntactical structure associated with the data;
replacing the resource string with the retrieved data;
obtaining the at least one user interface element;
replacing the parameter with the at least one element; and
outputting the data.

2. The method of claim 1, wherein the user interface is a graphical user interface, and the obtaining step involves obtaining at least one graphical user interface component.

3. The method of claim 1, wherein using the at least one resource string to retrieve the data involves using the at least one resource string as a key to retrieve the data from a database.

4. The method of claim 1, wherein obtaining involves creating the at least one user interface element.

5. In a computer system having a user and a graphical user interface containing at least one resource string, a method comprising:
identifying a locale associated with the user or the computer system;
using the resource string to retrieve data associated with the user's locale, wherein the data contains at least one parameter associated with at least one component of the user interface, the at least one parameter being integrated into a syntactical structure associated with the data;
replacing the resource string with the data;
obtaining the at least one component of the user interface;
replacing the at least one parameter with the at least one component; and
outputting the data.

6. The method of claim 5, wherein using the at least one resource string to retrieve data involves using the at least one resource string as a key to retrieve the data from a database.

7. The method of claim 5, wherein obtaining involves creating the at least one component of the user interface.

8. The method of claim 5, further including allowing the user to input a query via an input device, wherein the retrieving step is performed in response to the query.

9. A computer system comprising:
a memory containing:
a user interface program containing at least one resource string representing a data element, the data element containing at least one parameter associated with at least one component of the user interface program, wherein the user interface program:
replaces the resource string with the data element; and
replaces the at least one parameter with the at least one user interface component;
a display device for displaying the data element; and
a processor for running the user interface program.

10. The computer system of claim 9, wherein the user interface program is a graphical user interface.

11. The computer system of claim 9, wherein the data element is a textual message.

12. The computer system of claim 10, wherein the at least one component includes a graphical user interface component.

13. The computer system of claim 9, wherein the user interface program creates the at least one component of the user interface program.

14. The computer system of claim 9, wherein the user interface program retrieves the at least one component of the user interface program.

15. The computer system of claim 9, wherein the user interface program retrieves the data element.

16. The computer system of claim 15, wherein the user interface program uses the resource string as a key to retrieve the data element from a database.

17. The computer system of claim 16, wherein the database is remotely located with respect to the computer system.

18. A computer system comprising:
a memory comprising a user interface program, source code, and a compiler,
the user interface program containing at least one resource string representing data, the data containing at least one parameter associated with at least one component of a user interface,
the source code configured to:
retrieve the data associated with the at least one resource string;
replace the at least one resource string with the retrieved data;
obtain the at least one component of the user interface; and
replace the at least one parameter with the at least one component of the user interface, and
the compiler configured to compile the user interface program into object code; and
at least one processor for executing the user interface program, the source code, and the compiler.

19. The computer system of claim 18, wherein the user interface is a graphical user interface and the at least one component is a graphical user interface component.

20. The computer system of claim 18, wherein the data is associated with a locale and the class contains methods for identifying the locale.

21. The computer system of claim 18, wherein the class further contains methods for creating the at least one component of the user interface.

22. A computer-readable medium containing instructions for controlling a computer system to perform a method, the computer system having a user interface and a processor for executing the instructions, the method comprising the steps of:
retrieving at least one message containing at least one parameter, wherein said parameter represents at least one element of the user interface and is integrated into a syntactical structure associated with the message;
replacing the at least one parameter with the at least one element; and
making available to a user the at least one message.

23. The method of claim 22, wherein the user interface is a graphical user interface, the retrieving step involves retrieving a textual message, and the at least on element includes a graphical user interface component.

24. The method of claim 22, wherein the retrieving step involves retrieving the at least one message from a database.

25. The method of claim 22, further including creating the at least one element of the user interface.
